(19) United States
(12) Patent Application Publication
(10) Pub. No.: US 2007/0156748 A1
(43) Pub. Date: Jul. 5, 2007

(54) Method and System for Automatically Generating Multilingual Electronic Content from Unstructured Data

(76) Inventors: Ossama Emam, Mohandessen (EG); Hany Mohamed Hassan, Cairo (EG); Amr Yassin, Cairo (EG)

Correspondence Address: Jerry W. Herndon;International Business Machines, Intellectual Property Law, Dept. T81/Bldg. 503, PO Box 12195, Research Triangle Park, NC, 27709, US

(21) Appl. No.: 11/610,676

(22) Filed: Dec. 14, 2006

(30) Foreign Application Priority Data
Dec. 21, 2005 (EP) 05112722.3

(51) Int. Cl. G06F 7/00

(52) U.S. Cl. 707/102

(57) ABSTRACT

The present invention is directed to the field of electronic content management and more particularly to a method, system and computer program for automatically generating electronic content based on a user designed table of contents and a desired final content form. Language identification and automatic machine translation technologies are also used to broaden the sources of information, The method comprises the steps of: extracting from the unstructured data, information related to one or a plurality of preselected topics; consolidating the extracted information in a structured form; localizing the consolidated information according to a selected environment; generating content according to a specified form.

### TECHNICAL FIELD OF THE INVENTION

The present invention relates to information management system, and more particularly to a system, method and computer program for automatically generating multilingual electronic content from unstructured data.

### BACKGROUND ART

### Problem

The inclusion of electronic content (e-content) in learning is now Inevitable. The e-content is a new domain full of new challenges. The e-content development is the creation, design, and deployment of content and related assets including text, images, and animation. The management of objective-driven and multilingual content is a requirement to meet the high expectations of today's global enterprise.

The problem is that the traditional manual development of content may consume a huge amount of time. Moreover, the content “localization” (the adaptation of contents to a local environment) requires additional effort.

### Prior Art

US patent application 2003/0163784 entitled “Compiling and distributing modular electronic publishing and electronic instruction materials” discloses a system and method to facilitate the development, maintenance and modification of course and publication content because they may be located centrally in a large library of independent electronic learning and electronic content objects that serve as building blocks for electronic courses and publications. Modular CAI (Computer Aided Instruction) systems and methods can be used to monitor student progress both by administering examinations and tracking what content particular students have accessed and/or reviewed The invention includes authors using the Internet-accessed tools and templates to compile instructional and informational content, and the subsequent delivery of web-based instructional or informational content to end users such that the end users can receive and review such content using computing devices running standard web browsing applications.

The above-mentioned patent application assumes the existence of a large library of independent e-learning and e-content objects (structured materials) to build (compile) e-courses and publications. On the contrary, the present invention starts from scratch using unstructured input. The present invention has also the ability to handle multilingual material and to build relations between topics automatically.

US patent application 2004/205547 entitled “Annotation process for message enabled digital content” discloses an electronic message annotating method for providing interaction between instructor and student. The method involves displaying of annotation and its connection to a chosen subject item on visual displays. The method includes processes and techniques to:
(a) communicate abstract concepts through animated sequences of mathematical formulae, scientific expressions, and data visualizations;
(b) encode such expressions and visualizations in a way to facilitate their inclusion in messages exchanged by readers during educational discourse, and
(c) transfer and render such expressions, visualizations, and annotations to other users in the form of digitally transmitted display pages.

The method includes a technique to encode digital content in a fashion to allow for the creation of text messages and the convenient inclusion of annotations to reference both textual, and non-textual media elements. The main object of this method is the representation of the e-content during the content development.

The present invention goes beyond the systems disclosed above by providing a method for automatically generating e-content.

US patent application 2002/0156702 entitled “System and method for producing, publishing, managing and interacting with e-content on multiple platforms” discloses content production tools that incorporate the XML protocol with Object Oriented methodology to enable the production of effective displays. The claimed method and system unifies the production, delivery and display of content for all content platforms under one set of tools. The tools enable the production of platform-independent content without requiring a deep knowledge of programming.

The present invention goes beyond the system disclosed here above by providing a method for automatically generating e-content from unstructured data. However, the tools disclosed here above can be used at the final stage of the present invention.

### Related Art

Automatic Language Identification for Written Texts:

Some techniques for automatically identifying language in written text, use:
information about short words;
the independent probability of letters and the joint probability of various letter combinations;
n-grams of words;
n-grams of characters
diacritics and special characters:
syllable characteristics, morphology and syntax.

U.S. Pat. No. 5,062,143 entitled “Trigram-based method of language identification”, discloses a mechanism for examining a body of text and identifying its language. This mechanism compares successive trigrams into which the body of text is parsed with a library of sets of trigrams. For a respective language-specific key set of trigrams, if the ratio of the number of trigrams in the text, for which a match in the key set has been found, to the total number of trigrams in the text is at least equal to a prescribed value, then the text is identified as being possibly written in the language associated with that respective key set. Each respective trigram key set is associated with a respectively different language and contains those trigrams that have been predetermined to occur at a frequency that is at least equal to a prescribed frequency of occurrence of trigrams for that respective language. Successive key sets for other languages are processed as above, and the language for which the percentage of matches is greatest, and for which the percentage exceeded the prescribed value as above, is selected as the language in which the body of text is written.

Machine Translation:

“Machine Translation” is the translation from one natural language to another by means of a computerized system. Many different approaches have been adopted by machine translation researchers and there are many systems available in the market for different languages. These systems mainly fall into two categories.
the rule-based machine translation systems, and
the statistical machine translation systems.
   Text Searching/Automatic Information Retrieval:

The automatic retrieval of information from natural language text corpus is mainly based on the retrieval of documents matching one or more key words given in a user query. For instance, most conventional search engines on the Internet use a boolean search based on key words given by the user.

Some proposals are based on the creation of an information retrieval system that can find documents in a natural language text corpus that match a natural language query with respect to the semantic meaning of the query.

Some of these proposals relate to systems that have been extended with specific world knowledge within a given domain. Such systems are based on an extensive database of world knowledge within a single area.

Other proposals are based on underlying linguistic levels of semantic representation, In these proposals, instead of using verbatim matching of one or more key words a semantic analysis of the natural language text corpus and the natural language query is performed and the documents matching the semantic content meaning of the query, are returned.

Information Extraction:

“Information extraction” consists in extracting from text documents entities and relations among these entities. Examples of entities are “people”, “organizations”, and “location”. Examples of relations are “person-affiliation” and “organization-location”. The person-affiliation relation means that a particular person is affiliated with a certain organization. For instance, the sentence “John Smith is the chief scientist of the Hardcom Corporation” contains a person-affiliation relation between the person “John Smith” and the organization “Hardcom Corporation”.

“Information retrieval” gets sets of relevant documents (the user analyzes the documents) while “Information extraction” gets facts out of documents (the user analyzes the facts).

There are several approaches currently used for extracting information from natural language (e.g. Part of Speech Tagging and Entity Extraction). Hidden Markov Model (HMM) was perhaps the most popular approach for adaptive information extraction. HMMs exhibits excellent performance for name extraction [1] (Bikel et al., 1999). HMMs are mostly appropriate for modeling local and flat problems. The extraction of relations often involves the modeling of long range dependencies, for which the HMM methodology is not directly applicable.

Several probabilistic frameworks for modeling sequential data have recently been introduced to limit the HMM constraints:
Maximum Entropy Markov Models (MEMMs) [2] (McCallum et al., 2000) are able to model more complex transition and emission probability distributions and take into account various text features.
Conditional Random Fields (CRFs) [3] (Lafferty et al., 2001) are an example of exponential models.

As such, they both enjoy a number of attractive properties (e.g., global likelihood maximum) and are better suited for modeling sequential data, as contrasted with other conditional models.

Online learning algorithms for learning linear models (e.g. Perceptron, Winnow) are becoming increasingly popular for Natural Language Processing (NLP) problems [4] (Roth, 1999). These algorithms exhibit a number of attractive features such as incremental learning and scalability to a very large number of examples. Their recent applications to shallow parsing [5] (Munoz et al., 1999) and information extraction [6] (Roth and Yih, 2001) exhibit state-of-the-art performance.

More recent work focused on unsupervised methods for extracting relations between entities from unstructured text. For example the work presented in the article entitled “Extracting Paterns and Relations from the World Wide Web”, (by Sergy Brin—Computer Science Department Stanford University) published in “The proceedings of the 1998 International Workshop on the Web and Databases” is directed to the extraction of authorship information as found in books description on the World Wide Web. This publication is based on dual iterative pattern-relation extraction wherein a relation and pattern set is iteratively constructed.

The article entitled “Snowball: Extracting Relations from Large Plain-Text collections” (Eugene Agichtein and Luis Gravano—Department of Computer Science Columbia University), published in “Proceedings of the Fifth ACM International Conference on Digital Libraries”, 2000 discloses an idea similar to the previous work. Seed examples are used to generate initial patterns and to iteratively obtain further patterns. Then ad-hoc measures are deployed to estimate the relevancy of the patterns that have been newly obtained.

US patent application US 2004/0167907 entitled “Visualization of integrated structured data and extracted relational facts from free text” (Wakefield et al.) discloses a mechanism to extract simple relations from unstructured free text.

U.S. Pat. No. 6,505,197 entitled “System and method for automatically and iteratively mining related terms in a document through relations and patterns of occurrences” (Sundaresan et al.) discloses an automatic and iterative data mining system for identifying a set of related information on the World Wide Web that defines a relationship. More particularly, the mining system iteratively refines pairs of terms that are related in a specific way and the patterns of their occurrences in web pages. The automatic mining system runs in an iterative fashion for continuously and incrementally refining the relates and their corresponding patterns. In one embodiment, the automatic mining system identifies relations in terms of the patterns of their occurrences in the web pages. The automatic mining system includes a relation identifier that derives new relations, and a pattern identifier that derives new patterns. The newly derived relations and patterns are stored in a database, which begins initially with small seed sets of relations and patterns that are continuously and iteratively broadened by the automatic mining system.

U.S. Pat. No. 6,606,625 entitled “Wrapper induction by hierarchical data analysis” (Muslea et al.) discloses an inductive algorithm generating extraction rules based on user-labeled training examples.

### REFERENCES

[1] D. M. Bikel, R. Schwartz and R, M. Weiscohedel, “An Algorithm that Learns What's a name,” Machine Learning 34(1-3):211-231, 1999.
[2] D. Freitag and A. MaCallum, “Information extraction with HMM structures learned by stochastic optimization,” In the Proc. Of the 17th Conf. on Artificial Intelligence (AAAI-00) and of the 12th Conf. On Innovative Applications of Artificial Inteligence (IAAI-00), pages 584-589, Menlo Park, Calif., Jul. 30-Aug. 3, 2000, AAAI Press.
[3] J. Lafferty, A. McCailum and F. Pereira, “Conditional random fields: Probablistic models for segmenting and labeling sequence data,” In Proc. 18th International Conf. on Machine Learning, pages 282-289, Morgan Kaufmann, San Francisco, Calif., 2001.
[4] D. Roth, “Learnin in natural language,” In Dean Thomas, editor, Proc. Of the 16th International Joint Conf. On Artificial Intelligence (IJCAI-99-Vol2), pages 898-904, S.F., Jul. 31-Aug. 6, 1999, Morgan Kaufmann Publishers.
[5] M. Munoz, V. Punyakanok, D. Roth, and D. Zimak, “A learning approach to shallow parsing,” Technical Report 2087, University of Illinois at Urnana-Champaign, Urbana, Ill., 1999.
[6] D. Roth and W. Yih, “Relational learning via propositional algorithms: An information extraction case study,” In Bernhard Nebel, editor, Proc. Of the 17th International Conf. on Atrificial Intelligence (IJCAI-01), pages 1257-1263, San Francisco, Calif., Aug. 4-10, 2001, Morgan Kaufmann Publishers, Inc.

### SUMMARY OF THE INVENTION

The present invention is directed to the field of electronic content management and more particularly to a method, system and computer program for automatically generating electronic content based on a user designed table of contents and a desired final content form, Language identification and automatic machine translation technologies are also used to broaden the sources of information.

The method for automatically generating and localizing electronic content from unstructured data based on user preferences, comprises the steps of:
extracting from the unstructured data: information related to one or a plurality of preselected topics;
consolidating the extracted information in a structured form;
localizing the consolidated information according to a selected environment;
generating content according to a specified form.

More particularly, the method according to the present invention comprises the further steps of:
receiving one or a plurality of preselected topics;
receiving a user selected environment;
receiving a user specified form;
optionally, identifying the languages used in the unstructured data;
optionally, converting the unstructured data into a single language;
extracting from the unstructured data, information related to one or a plurality of preselected topics; said step comprising for each preselected topic, the further steps of:
   retrieving from the unstructured data, contents related to the topic;
   measuring the relevancy of the retrieved contents for the topic;
   selecting from the retrieved contents, the contents considered as the most relevant for the topic;
   tagging the selected contents according to one or a plurality of predefined categories;
   identifying from the tagged contents, related named entities and relations between said named entities;
   extracting a feature vector from the unstructured data for each identified named entities and relations;
   representing said entities and relations in a topic graph wherein nodes represent the entities and edges represent the relations between said entities;
consolidating the extracted information in a structured form; said step comprising the further steps of;
   merging all the topic graphs associated with the different topics and if a same sub-topic is represented in more than one topic graph:
      preserving only one instance of the sub-topic data in a topic graph;
      using a reference to refer to the sub-topic data in any other topic graph;
localizing the consolidated information; said step comprising the further step of:
   adapting the consolidated information to a selected environment; and
   optionally, translating the consolidated information according to a user selected language.

An advantage of the present invention is that the user can configure an automatic digital content generator to generate electronic contents according to the form and and language of its choice.

The foregoing, together with other objects, features, and advantages of this invention can be better appreciated with reference to the following specification, claims and drawings.

### BRIEF DESCRIPTION OF THE DRAWINGS

The new and inventive features believed characteristic of the invention are set forth in the appended claims. The invention itself, however, as well as a preferred mode of use, further objects and advantages thereof, will best be understood by reference to the following detailed description of an illustrative detailed embodiment when read in conjunction with the accompanying drawings, wherein:

FIG. 1 shows a basic application of the Automatic Digital Content Generator (ADCG) according to the present invention.

FIG. 2 is a detailed view of the Automatic Digital Content Generator (ADCG) according to the present invention.

FIG. 3 is a detailed view of the Information Extractor included in the Automatic Digital Content Generator (ADCG) according to the present invention.

FIG. 4 is a detailed view of the Structured information Generator part of the Automatic Digital Content Generator (ADCG) according to the present invention.

FIG. 5 shows the Graph-based Hierarchical Topic Representation output of the Information Extractor according to the present invention.

### PREFERRED EMBODIMENT OF THE INVENTION

The following description is presented to enable one or ordinary skill in the art to make and use the invention and is provided in the context of a patent application and its requirements, Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

Definitions

Content: information presenting an interest for a human being—sound, text, pictures, video, etc. Content is a generic term used to describe information in a digital context. It can take the form of web pages, as well as sound, text, images and video contained in files (documents).
Information: data with a meaning created to give some knowledge to the person who receives it.
Data: a collection of facts from which conclusions may be drawn (for instance: “statistical data”).
Document: writing comprising information.
Metadata: data used to describe other data. Examples of metadata include schema, table, index, view and column definitions.
Text: A mixture of characters that are read from left to right and characters that are read from right to left.
Hypertext: text with links to other text.

In the present invention. the terms: “information”, “data”, and “documents” will be used for the same purpose.

General Principles

The present invention combines automatic text analysis, information searching and information extraction techniques for automatically generating from unstructured information (books, web contents, . . . etc), digital contents for e-learning. The present invention proposes a system and method for automatically developing and localizing (adapting to the local environment) multi-lingual e-content. The present invention proposes the integration of some known technologies and propose some new technologies to contribute to the e-content development of the e-learning market. Many publications world-wide disclose aspects of automatic text analysis, information searching and information extraction techniques. In similar fashion, some references disclose systems and techniques of using the above mentioned technologies. However, none of these references disclose the combination of steps and means claimed in the present invention.

General View of the Invention

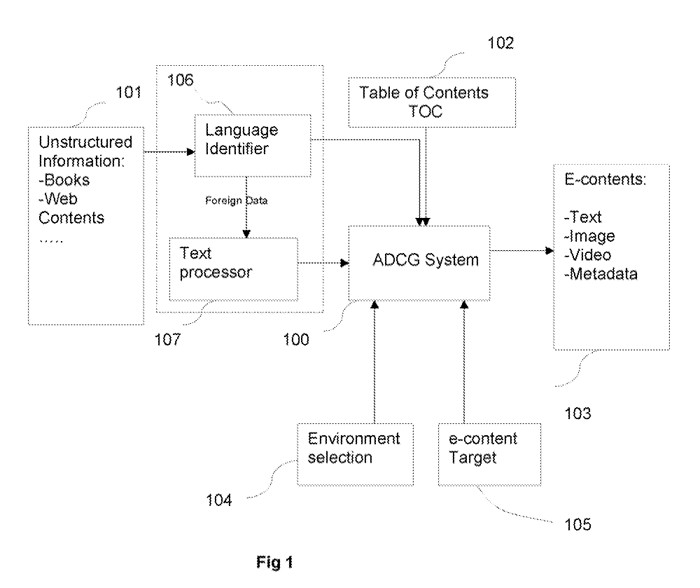

FIG. 1 shows a basic application of the “Automatic Digital Content Generator” (ADCG) according to the present invention.
The ADCG (100) receives:
   unstructured information from on-line books, web, etc. (101), and
   input from the user, such as:
      the desired Table of Contents (TOC) (102)
      the environment selection (104), (language, target audience, place, region, . . . etc.) and
      the desired final form for the e-content in output (105).
The ADCG outputs the econtent (text, images, video, etc.) in a final form previously specified by the user (103).
   Automatic Digital Content Generator

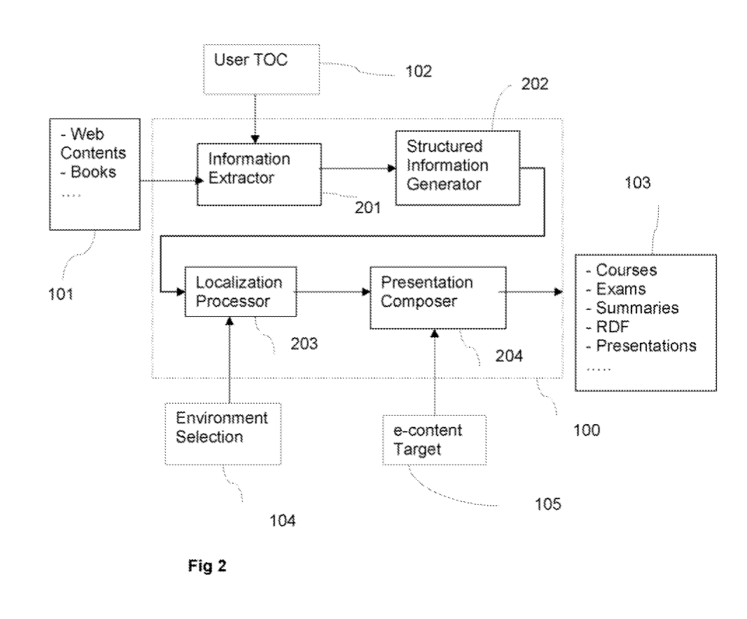

FIG. 2 illustrates the various systems and information that are utilized with the Automatic Digital Content Generator (ADCG). In this figure, a dotted line (100) encloses the components of the ADCG. The ADCG includes:
an information extractor (201), for extracting the relevant information related to each topic specified in the Table of Contents
a structured information generator (202), for consolidating the extracted information in a structured form and for producing a preliminary e-content output.
a localization processor (203), for localizing the preliminary e-ontent output using the environment selection input (language, target audience, place, region . . . etc.), and
a presentation composer (204), for producing e-content in a desired final form (courses, exams, summaries, RDF, presentations . . . etc.).

How the Information Extractor (201), the Structured Information Generator (202), and the full ADCG system (100) operate will be described using the following example where a user wishes to develop e-contents for a Table of Contents TOC having the following list of topics:
Topic 1 (T1)
Topic 2 (T2)
. . .
Topic N (TN)

The design of the Table Of Contents (TOG) is done by the user (102). The TOC is used to feed the ADCG system (100).

Information Extractor

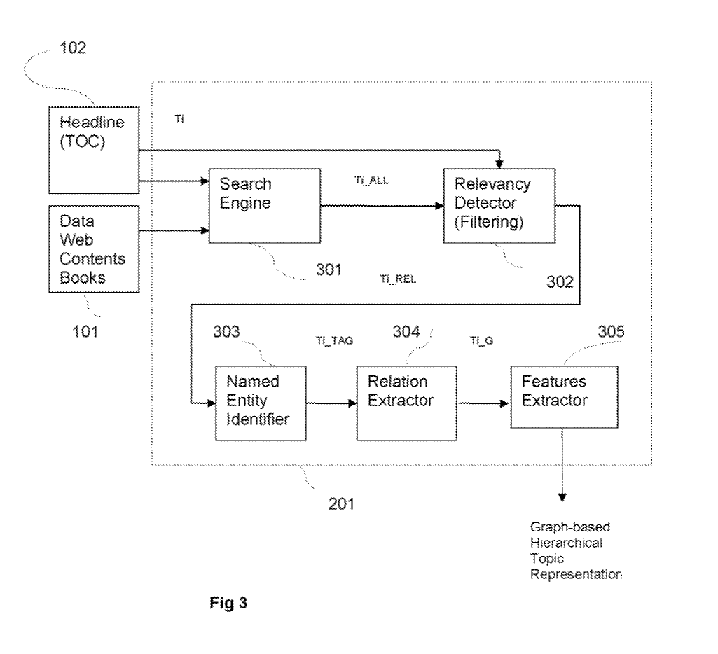

FIG. 3 describes the Information Extractor (201). The extraction of the information is performed as follows:

For each Topic (Ti) in the Table of Contents (TOC):
(301): A Search Engine (301) retrieves from the unstructured information (101) all the contents Ti_ALL related to the current topic (Ti). Such Search Engine systems (e.g. Google. Yahoo, AltaVista, Lycos, . . . etc) are well known and are part of the state of the art. However a Search Engine tends to retrieve a huge amount of related content and therefore it is necessary to check the relevancy of the retrieved contents.
(302): A Relevancy Detector (302) checks the relevancy of the contents Ti_ALL retrieved from the unstructured information. A relevancy score (similar to scores used in common search engines) is used to measure the relevancy of the contents Ti_ALL. A threshold is used to determine whether the contents are relevant or not.
   irrelevant contents are filtered out.
   Only the most relevant contents Ti_REL for the topic (Ti) are selected.
   The threshold value can be tuned based on the user judgment.
(303): The selected contents Ti_REL are used by a Named Entity (NE) identifier (303). This Named Entity Identifier tags the selected contents Ti_REL according to predefined categories. These categories may be for instance:
   Person names,
   Location names,
   Country names,
   Animals names,
   Products,
   Organizations,
   Vehicles.
(304): The data Ti_TAG tagged by the Named Entity Identifier (303) is used by a Relation Extractor (304) to identify the related named entities and to extract the relations between said named entities. To extract relations and related entities, the Relation Extractor 304 may use one of the methods described in the related art. One way of extracting relations and related entities is the use of patterns with associated confidence measurements. In this case, the process of inducing (automatically acquiring) patterns is performed once and offline during the building of the system. Patterns are induced using a general framework that can be used for any entity and relation type. At run-time, the induced patterns are applied to the unstructured text to extract the entities and their associated relations.
(305): The Relation Extractor (304) output which represent the related named entities and their associated relations, is used as input of the Features Extractor (305). The Feature Extractor (305) extracts from the unstructured data a feature vector for each named entity and relation. The features associated with each entity and relation include many types of data such as:
   text including the related entities and the relations between these entities,
   hyperlinks to more information,
   most related entities to the entity under consideration,
   relations between different entities,
   features for different entities and relations,
   . . .

It is worth mentioning that the proposed system can accommodate to any type of features. The output of the Relation Extractor (304) represents named entities and relations between said named entities. A features vector is associated with each named entity and relation. This feature vector includes many information regarding the associated entity or relation.

The entities and relations are represented in a directed graph in which the nodes represent the entities and the edges represent the relations between the different entities. The topic (Ti) is also represented by a node in the graph, and all other nodes are candidate sub-topics. The output of the Feature Extractor (305) is, therefore, a Graph-based Hierarchical Topic Representation Ti_G.

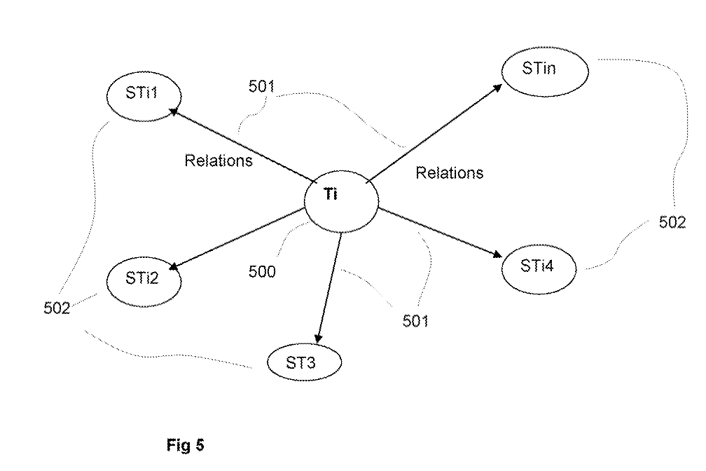

The steps 301 to 305 are repeated in order to generate a graph for each topic comprised in the Table Of Contents (TOC). FIG. 5 shows a Graph-based Hierarchical Topic Representation Ti_G of a topic (Ti). The Graph-based Hierarchical Topic Representation Ti_G is the output of the Structured Information Generator where a topic (Ti) is represented by a node 500 and the relations between this topic and other candidate sub-topics 502 (STi1, STi2, . . . , STin, where n is the number of sub topics) are represented by edges 501.

Structured Information Generator

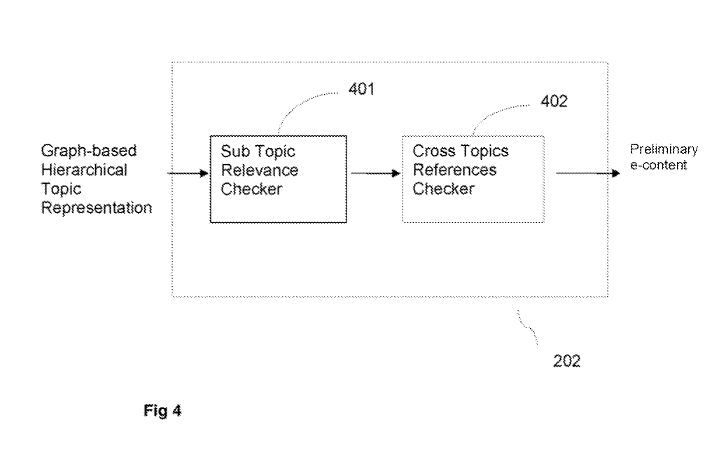

FIG. 4 describes the Structured Information Generator (202).

Each Graph-based Topic Representation Ti_G is passed to the Structured Information Generator (202) which performs the following step:
(401): A Sub-Topic Relevance Checker (401) parses the graph Ti_G and ranks the different nodes based on their relevance to the main topic (Ti) according to a scoring function. The scoring function measures different factors to determine whether a node representing a sub-topic is relevant to the main topic (Ti) or not. The relevancy score between Ti and Node STj is represented as follows:
   Score=−log(Dist(Ti_Features,STj_Features))
   Nodes with a high score are considered as relevant sub-topic and are kept while nodes with a low score are rejected.

Then, based on all Graph-based topic Representations Ti-G in output of the Sub-Topic Relevance Checker (401), the Structured Information Generator (202) performs the following step,
(402): A Cross Topics References Checker (402) detects topic duplications and identify subtopics that appear in more than one topic graph. This is done by merging all the topic graphs based on the different topics. The input to this step comprises all the graphs associated with the different topics. In other words if the same sub-topic is represented in more than one topic graph only one instance of the sub-topic data is preserved in a graph. A reference is used to refer to this sub-topic data in any other graph. Thus, any duplication is removed.
   Localization Processor

As previously shown in FIG. 2, a Localization Processor (203) localizes the output generated by the Structured Information Generator (202) based on an environment selected by the user (language, target audience, place, region . . . etc.). The output is adapted to the user's environment: the content is translated, relevant images are chosen.

Presentation Composer

The generated structured content is then passed to a Presentation Composer (204) which uses the user selection of the type of materials needed (course, exam, summary, presentation., RD . . . etc.) to compose the final e-content.

Language Identifier and Text Processor

Note that the ADCG system is fed by unstructured information that can be in more than one language. A Language Identifier (106) can be used with a Text Processor (107) (optional as shown in FIG. 1) to convert the information into a single language, for example English (as it is the most used language for the contents) and later depends on the Localization Processor (203) to convert to the target language. For instance, the Text Processor (107) translates the English text into French. The Text Processor (107), in this case, is a conventional, commercially available Automatic Machine Translation (AMT) system.

Particular Embodiment

In a particular embodiment the present invention is executed by a content provider in a server, The server receives the requests and preferences (list of topics, selected environment, specified form) from clients and sends back to said clients the requested content in the specified form.

While the invention has been particularly shown and described with reference to a preferred embodiment, it will be understood that various changes in form and detail may be made therein without departing from the spirit, and scope of the invention.

What we claim is:

1. A method for automatically generating and localizing electronic content from unstructured data based on user preferences, said method comprising the steps of:
extracting from the unstructured data, information related to one or a plurality of preselected topics;
consolidating the extracted information in a structured form;
localizing the consolidated information according to a selected environment;
generating content according to a specified form.

2. The method according to claim 1 wherein the topic to which the extracted information is related, the environment according to which the information is localized and the form according to which the content is generated, are based on user preferences.

3. The method according to claim 1 further comprising the preliminary step of:
receiving one or a plurality of preselected topics.

4. The method according to claim 3 further comprising the preliminary step of:
receiving a user selected environment.

5. The method according to claim 3 further comprising the preliminary step of:
receiving a user specified form.

6. The method according to claim 1 wherein the step of extracting from the unstructured data, information related to one or a plurality of preselected topics, comprises the further steps of:
for each preselected topic:
retrieving from the unstructured data, contents related to the topic;
measuring the relevancy of the retrieved contents for the topic;
selecting from the retrieved contents, the contents considered as the most relevant for the topic;
tagging the selected contents according to one or a plurality of predefined categories;
identifying from the tagged contents, related named entities and relations between said named entities;
extracting a feature vector from the unstructured data for each identified named entities and relations;
representing said entities and relations in a topic graph wherein nodes represent the entities and edges represent the relations between said entities.

7. The method according to claim 6 wherein in a topic graph, a preselected topic is represented by a node, sub-topics are represented by other nodes, and the relations between the preselected topic and the sub-topics are represented by edges.

8. The method according to claim 1 wherein the step of consolidating the extracted information in a structured form comprises the further steps of:
for each topic graph related to each preselected topic:
a selecting sub-topics considered as relevant to the preselected topic;
a removing sub-topics considered as not relevant to the preselected topic.

9. The method according to claim 8 wherein the step of consolidating the extracted information in a structured form comprises the further steps of:
merging all the topic graphs associated with the different topics and detecting sub-topics represented in more than one topic graph;
for each sub-topic represented in more than one topic graph;
preserving only one instance of the sub-topic data in a topic graph;
using a reference to refer to the sub-topic data in any other topic graph.

10. The method according to claim 1 wherein the step of localizing the consolidated information, comprises the further step of:
adapting the consolidated information to a selected environment.

11. The method according to claim 10 wherein the step of adapting the consolidated information to a selected environment, comprises the step of:
a translating the consolidated information according to a user selected language.

12. The method according to claim 1 further comprising the preliminary step of:
converting the unstructured data into a single language.

13. The method according to claim 12 wherein the step of converting the unstructured data into a single language, comprises the step of:
identifying the languages used in the unstructured data.

14. The method according to claim 1 wherein said method is executed in a server; said method comprising the further steps of:
receiving requests comprising user preferences from one or a plurality of clients;
sending back to clients contents according to user preferences in response to said requests.

15. A system for automatically generating and localizing electronic content from unstructured data based on user preferences, comprising:
Means for extracting from the unstructured data, information related to one or a plurality of preselected topics;
Means for consolidating the extracted information in a structured form;
Means for localizing the consolidated information according to a selected environment; and
Means for generating content according to a specified form.

16. A storage medium containing computer program code for controlling a computer to perform the steps of:
extracting from the unstructured data, information related to one or a plurality of preselected topics;
consolidating the extracted information in a structured form;
localizing the consolidated information according to a selected environment; and generating content according to a specified form.
